(19) United States
(12) Patent Application Publication
(10) Pub. No.: US 2007/0188023 A1
(43) Pub. Date: Aug. 16, 2007

(54) Modular building block instrument cluster

(75) Inventors: Karen M. Kraus, Farmington Hills, MI (US); Rebecca Paskaramoorthy, Farmington Hills, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/352,030

(22) Filed: Feb. 10, 2006

(51) Int. Cl. B60L 1/00

(52) U.S. Cl. 307/10.1

(57) ABSTRACT

A modular instrument cluster for a motor vehicle including a self-contained hub adapted to be mounted within the instrument panel. The self-contained hub contains a plurality of displays for displaying information to a driver of the vehicle and further includes a communications interface to allow communication between the self-contained hub and other assemblies within the vehicle. At least one peripheral module is removably mounted to the self-contained hub. The peripheral module also contains at least one display for displaying information to a driver of the vehicle.

### BACKGROUND

1. Field of the Invention

The invention relates generally to an instrument panel and more particularly to an instrument panel cluster made up of modular components.

2. Related Technology

In current instrument panel clusters, the ability to change the features and appearance of the cluster are limited. Changing the appearance and/or functionality of the instrument panel cluster may require many changes at the manufacturing level. These changes might include changes such as populating or depopulating by addition or removal of motors and/or LEDs (light emitting diodes). These changes may also require plugging in or removing portions of the plastic back plate. Still other prior art instrument panels incorporate separate gauges that are hard wired at various locations, such as beneath the instrument panel or on a pillar.

Therefore, there is a need for an instrument panel cluster that allows relatively easy modification to the appearance and functionality of the cluster.

### SUMMARY

In overcoming the above limitations and other drawbacks, a modular instrument cluster for a motor vehicle is provided. In one aspect, the modular instrument cluster includes a self-contained hub that is adapted to be mounted within the instrument panel and contains a plurality of displays for displaying information to a driver of the vehicle. The self-contained hub further includes a communication module having a microprocessor, a power supply and a communications interface to allow communication between the self-contained hub and other assemblies within the vehicle. At least one peripheral module is removably mounted to the self-contained hub and includes at least one display for displaying information to a driver of the vehicle.

In another aspect of the invention, each of the displays within the self contained hub and the peripheral module are one of a speedometer, an odometer, a warning symbol array, a fuel gauge, turn signal indicators, an oil pressure gauge, an engine temperature gauge, and a tachometer. The displays may be digital or analog in nature.

In still another aspect, one or both of the self-contained hub and the peripheral module includes at least one control device, such as a switch to allow the operator of the vehicle to selectively activate a component of the vehicle, such as the headlights, the windshield wiper, the temperature setting of a climate control system, the fan speed of a climate control system, or radio controls.

In yet another aspect, the self-contained hub includes an electro-mechanical interconnect that provides a mechanical and an electrical connection between the self-contained hub and the peripheral module when the peripheral module is mounted onto the self-contained hub. The electrical connection may be through a pair of conductors wherein one of the conductors carries power and the other ground. A third conductor may also be used to accommodate a communications interface.

In still another aspect, the peripheral module is mounted onto the self-contained hub and secured thereto by a ramp lock connector.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a plan view of a self-contained hub for the modular instrument cluster of the present invention;

FIG. 2 is a plan view of a peripheral module for the modular instrument cluster of the present invention;

FIGS. 3A-3E are plan views showing different peripheral modules of different styles;

FIG. 4 is a partially exploded rear view of a self-contained hub having one peripheral module mounted onto one side and a second peripheral module being mounted onto another side thereof; and

FIGS. 5A-5C are side views showing the peripheral module being brought into contact with and connected to the self-contained hub via a ramp lock connection.

### DETAILED DESCRIPTION

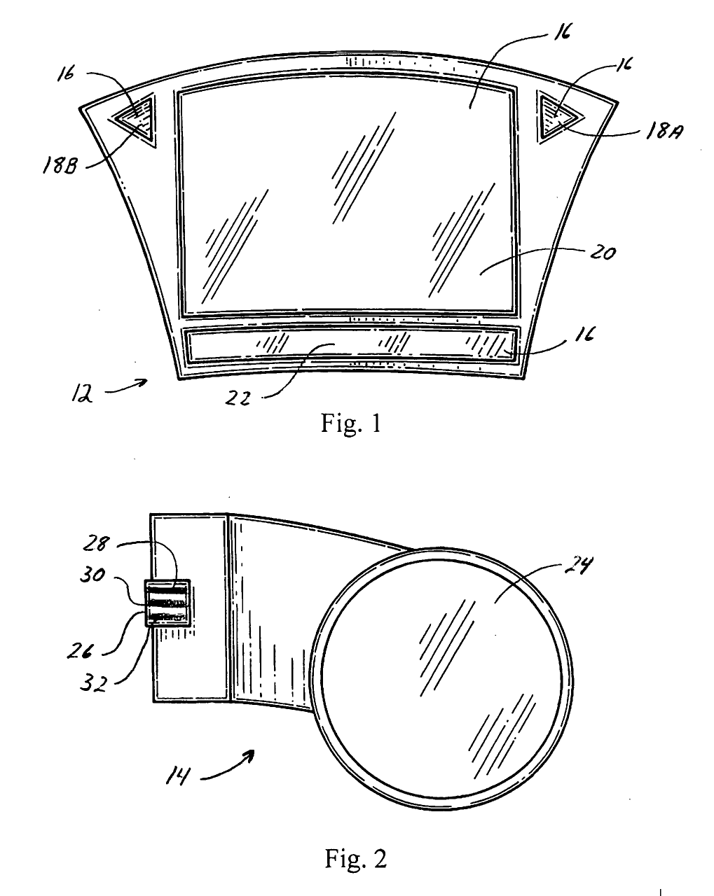

A modular instrument cluster 10 in accordance with the claims of the present invention includes a self-contained hub 12 and at least one peripheral module 14 removeably mounted thereon. Referring to FIG. 1, the self-contained hub 12 is adapted to be mounted within an instrument panel of a motor vehicle (not shown).

The self-contained hub 12 includes a plurality of displays 16 for displaying information to a driver of the vehicle. The displays 16 can be any digital or analog gauge or indicator that is appropriate for use in a motor vehicle. For example, the display 16 could be a speedometer, an odometer, a warning symbol array, a fuel gauge, turn signal indicators, an oil pressure gauge, an engine temperature gauge, or a tachometer. The examples listed above are meant to be illustrative only, and are not meant to limit the application to these examples.

As illustrated in FIG. 1, the self-contained hub 12 includes displays 16 for turn signal indication, including a right turn indicator 18A and a left turn indicator 18B. A center panel 20 is used to display different gauge indications as discussed above, and an array of warning symbols 22 are positioned below the center panel 20. As will be appreciated by those skilled in the art, the warning symbols 22 can be any suitable for use in a motor vehicle, such as a low oil warning light, an engine temperature warning light, etc.

The self-contained hub 12 may further include a communication module having a microprocessor on a printed circuit board, and a communications interface coupled to a power supply to allow communication between the self-contained hub and other assemblies within the vehicle.

At least one peripheral module 14 is mounted to the self-contained hub 12. Referring to FIG. 2, the peripheral module 14 includes at least one display 24 for displaying information to a driver of the vehicle.

Like the self-contained hub 12, the displays 24 in the peripheral module 14 can be any digital or analog gauge or indicator that is appropriate for use in a motor vehicle. By way of example, and not limitation, the display could be a speedometer, an odometer, a telltale warning symbol array, a fuel gauge, turn signal indicators, an oil pressure gauge, an engine temperature gauge, or a tachometer.

In addition to the displays 16, 24, either the self-contained hub 12 or the peripheral module 14 or both could also include a mechanical or electrical control device. The control device could include a switch or button displayed on the self-contained hub 12 or the peripheral module 14, wherein the display 16, 24 is touch sensitive, and the button or switch allows the operator of the vehicle to selectively activate and control a component or feature of the vehicle. For example, the display 16, 24 of either the self-contained hub 12 or the peripheral module 14 could include a touch screen switch for activation of the headlights of the vehicle, the windshield wipers, the temperature settings or the fan speed of the vehicle climate control system, or controls for the audio system within the vehicle. These examples are also merely listed for illustrative purposes, and could include any other control or switch needed within an automotive vehicle.

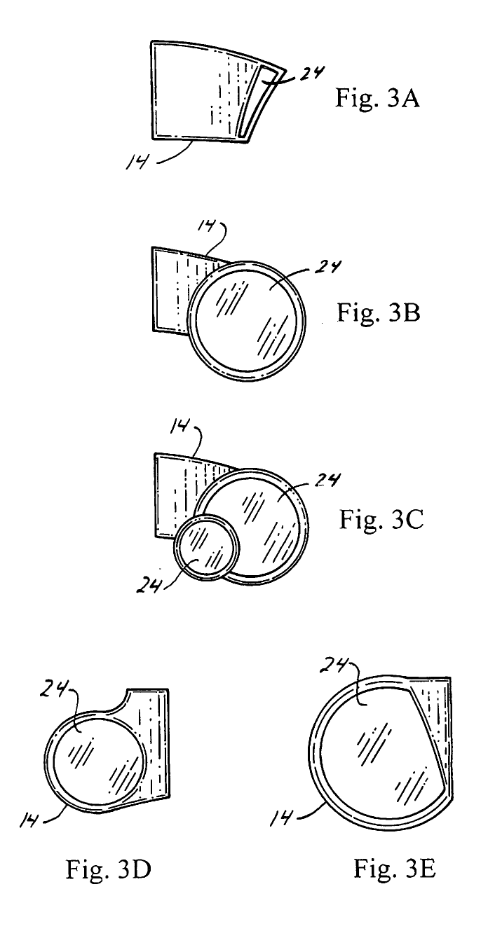

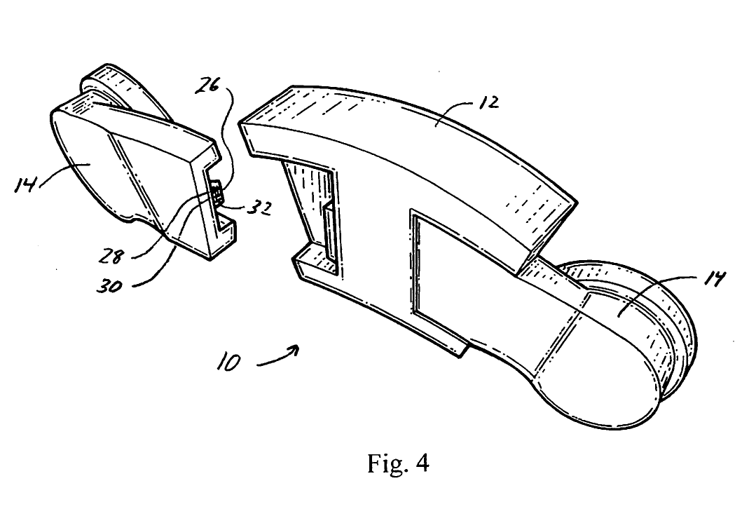

One key advantage of the present invention is that the peripheral module 14 or modules 14 can be of any suitable size and shape and may include different application specific, functional features. As such, the instrument panel may include a self-contained hub 12 having one, two, or three peripheral modules 14 attached thereto. Further, the peripheral modules 14 can be designed and selected to give a particular look to any given application. Referring to FIGS. 3A through 3E, several different styles of peripheral modules 14 are illustrated. The interchangeability of the peripheral modules 14 allows different vehicles to have different and distinct characteristics using common components that are compatible and interchangeable. Aftermarket purchasing of different peripheral modules 14 would allow the owner of a vehicle to change the layout of the instrument cluster 10 in his or her vehicle.

Referring to FIG. 4, the self-contained hub 12 includes an electro-mechanical interconnect 26 that provides a mechanical and electrical connection between the self-contained hub 12 and the peripheral module 14. Referring again to FIG. 4 and also to FIG. 2, the electrical connection between the peripheral module 14 and the self-contained hub 12 is through a series of conductors 28, 30, 32 for carrying power, ground, and communication signals to the display at the peripheral module.

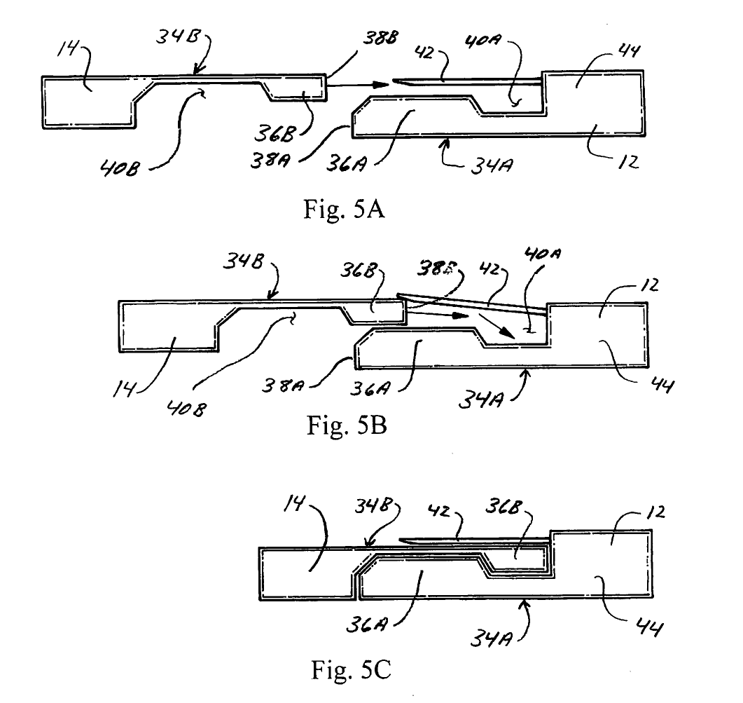

The mechanical or electro-mechanical connection between the self-contained hub 12 and the peripheral module 14 is achieved through any suitable connection means, as long as the peripheral module 14 is attached to the self-contained hub 12 in a way that is secure enough to maintain the electrical connection and stability of the cluster 10. Referring to FIGS. 5A through 5C, one such connection method involved the use of a ramp lock.

As shown in FIGS. 5A-5C, each of the self-contained hub 12 and the peripheral module 14 includes an extending lip 34A, 34B. Each extending lip 34A, 34B includes a ridge 36A, 36B respectively formed at a distal end 38A, 38B thereof, thereby defining a channel 40A, 40B adjacent to the ridges 36A, 36B. The self-contained hub 12 also includes a flexible extension 42 that extends from a main body 44 of the self-contained hub 12, parallel to the extending lip 34A, outward to a location at least beyond the width of the channel 40A.

As seen in FIG. 5B, as the peripheral module 14 is brought into contact with the self-contained hub 12, the flexible extension 42 is caused to deflect outward to allow the extending lip 34B of the peripheral module 14 to fit between the extending lip 34A of the self-contained hub 12 and the flexible extension 42. Referring to FIG. 5C, as the two are connected, the extending lip 34B of the peripheral module 14 reaches a point where the ridge 36B formed on the extending lip 34B of the peripheral module 14 fits within the channel 40A defined within the extending lip 34A of the self-contained hub 12. Likewise, the extending lip 34A of the self-contained hub 12 reaches a point where the ridge 36A formed on the extending lip 34A of the self-contained hub 12 fits within the channel 40B defined within the extending lip 34B of the peripheral module 14. When the two extending lips 34A, 34B engage in this manner, the flexible extension 42 of the self-contained hub 12 will flex back to the original position and provide pressure to keep the extending lips 34A, 34B of the self-contained hub 12 and the peripheral module 14 engaged with one another.

It is therefore intended that the foregoing detailed description be regarded as illustrative rather than limiting, and that it be understood that it is the following claims, including all equivalents, that are intended to define the spirit and scope of this invention.

What is claimed is:

1. A modular instrument cluster for a motor vehicle comprising:
a self-contained hub adapted to be mounted within the instrument panel, the hub including at least one display configured to provide information to a driver of the vehicle;
at least one peripheral module removably mounted to the hub at a connection interface, the peripheral module including at least one display configured to provide information to the driver of the vehicle; and
wherein the connection interface electro-mechanically connects the hub to the peripheral module.

2. The modular instrument cluster of claim 1, wherein the display of the hub is one of a speedometer, an odometer, a warning symbol array, a fuel gauge, a turn signal indicator, an oil pressure gauge, an engine temperature gauge, and a tachometer.

3. The modular instrument cluster of claim 1 wherein the display of the peripheral module is one of a speedometer, an odometer, a warning symbol array, a fuel gauge, a turn signal indicator, an oil pressure gauge, an engine temperature gauge, and a tachometer.

4. The modular instrument cluster of claim 1 wherein the hub further includes at least one control device.

5. The modular instrument cluster of claim 4 wherein the control device is a switch configured to allow the operator of the vehicle to selectively activate a component of the vehicle.

6. The modular instrument cluster of claim 4 wherein the control device is a switch configured to allow the operator of the vehicle to selectively activate one of the headlights, the windshield wipers, the temperature setting of a climate control system, the fan speed of a climate control system, and radio controls.

7. The modular instrument cluster of claim 1 wherein the peripheral module further includes at least one control device.

8. The modular instrument cluster of claim 7 wherein the control device is a switch configured to allow the operator of the vehicle to selectively activate a component of the vehicle.

9. The modular instrument cluster of claim 8 wherein the control device is a switch configured to allow the operator of the vehicle to selectively activate one of the headlights, the windshield wipers, the temperature setting of a climate control system, the fan speed of a climate control system, and radio controls.

10. The modular instrument cluster of claim 1 wherein the connection interface provides a mechanical and an electrical connection between the hub and the peripheral module.

11. The modular instrument cluster of claim 10 wherein the hub includes a controller adapted to provide a control signal to the display of the peripheral module.

12. The modular instrument cluster of claim 11 wherein the electrical connection between the peripheral module and the self-contained hub further includes a third conductor to accommodate a communications interface.

13. The modular instrument cluster of claim 10 wherein the connection interface is a ramp lock connector.

14. The modular instrument cluster of claim 1 wherein the displays on the hub and the peripheral module are one of digital and analog displays.
